(19) United States
(12) Patent Application Publication
(10) Pub. No.: US 2024/0174562 A1
(43) Pub. Date: May 30, 2024

(54) RESIN COATING DEVICE, APPARATUS FOR PRODUCING OPTICAL FIBER, AND METHOD OF PRODUCING OPTICAL FIBER

(71) Applicant: SUMITOMO ELECTRIC INDUSTRIES, LTD., Osaka (JP)

(72) Inventors: Kazumasa OISHI, Osaka (JP); Satoshi YOSHIKAWA, Osaka (JP)

(21) Appl. No.: 18/482,981

(22) Filed: Oct. 9, 2023

(30) Foreign Application Priority Data
Nov. 28, 2022 (JP) 2022-189015

(51) Int. Cl. C03C 25/105; C03C 25/20; C03C 25/26

(52) U.S. Cl. CPC C03C 25/105; C03C 25/20; C03C 25/26

(57) ABSTRACT

A resin coating device includes: a resin application portion having an insertion hole through which a glass fiber is inserted in an axial direction, and applying a resin onto an outer circumference of the glass fiber in the insertion hole; a θₓ rotation mechanism rotating the resin application portion with a θₓ axis orthogonal to a central axis of the insertion hole as a central axis of rotation; and a θy rotation mechanism rotating the resin application portion with a θ_{y} axis orthogonal to both of the central axis of the insertion hole and the θₓ axis as a central axis of rotation, wherein the θₓ rotation mechanism and the θ_{y} rotation mechanism are configured such that a center point of rotation, which is an intersection of the θₓ axis and the θ_{y} axis, is located within the insertion hole.

### TECHNICAL FIELD

The present disclosure relates to a resin coating device, an apparatus for producing an optical fiber, and a method of producing an optical fiber.

The present application claims priority based on Japanese Patent Application No. 2022-189015 filed on Nov. 28, 2022, the content of which is incorporated herein by reference in its entirety.

### BACKGROUND

In an optical fiber production step, a resin coating device is used to cover an outer circumference of a glass fiber with a resin. In the resin coating device, it is required to adjust a tilt angle of a die and the like (for example, PTL. 1).
PTL. 1: Japanese Laid-Open Patent Publication No. S61-091047

### SUMMARY

According to an aspect of the present disclosure,
there is provided a resin coating device, including:
a resin application portion having an insertion hole through which a glass fiber is inserted in an axial direction, and applying a resin onto an outer circumference of the glass fiber in the insertion hole;
a θₓ rotation mechanism rotating the resin application portion with a θₓ axis orthogonal to a central axis of the insertion hole as a central axis of rotation; and
a θ_{y} rotation mechanism rotating the resin application portion with a θ_{y} axis orthogonal to both of the central axis of the insertion hole and the θₓ axis as a central axis of rotation,
wherein the θₓ rotation mechanism and the θ_{y} rotation mechanism are configured such that a center point of rotation, which is an intersection of the θₓ axis and the θ_{y} axis, is located within the insertion hole.

### BRIEF DESCRIPTION OF THE DRAWINGS

FIG. 1 is a schematic configuration diagram illustrating an apparatus for producing an optical fiber according to an embodiment of the present disclosure.

FIG. 2 is a schematic perspective diagram of a resin coating device according to an embodiment of the present disclosure.

FIG. 3 is a schematic diagram illustrating an XZ cross-section including an insertion hole of a resin application portion in the resin coating device.

FIG. 4 is a schematic diagram illustrating a YZ cross-section including an insertion hole of the resin application portion in the resin coating device.

FIG. 5 is a schematic cross-sectional diagram of the resin application portion.

FIG. 6 is a schematic diagram illustrating a resin pressure distribution in the resin application portion.

### DETAILED DESCRIPTION

### Problem to be Solved by the Present Disclosure

An object of the present disclosure is to suppress eccentricity of a glass fiber.

### Advantageous Effect of the Present Disclosure

According to the present disclosure, eccentricity of a glass fiber can be suppressed.

### Description of Embodiment of the Present Disclosure

### Knowledges Obtained by the Inventors

First, the knowledges obtained by the inventors will be described.

The resin coating device of Comparative Examples 1 and 2, which have been used in the conventional optical fiber production step, may cause problems such as (i) or (ii), for example.

### (i) Resin Coating Device of Comparative Example 1

The resin coating device of Comparative Example 1 has, for example, a biaxial tilt stage as a mechanism to adjust a tilt angle of a die.

The “biaxial tilt stage” integrally includes a mechanism that enables tilt adjustment with two axes as the central axes of rotation. For example, it includes a support base, a θₓ tilt table, and a θ_{y} tilt table, in this order upwardly in a vertical direction.

However, in Comparative Example 1, either one of a θₓ axis, the central axis of rotation of a θₓ rotary table, and the θ_{y} axis, the central axis of rotation of the θ_{y} tilt table, does not intersect with a Z axis located at the center of each stage. Therefore, even though an opening is provided at the center of the stage and an insertion hole of a die through which a glass fiber is inserted is placed at the center of the stage, either one of the θₓ axis and the θ_{y} axis is apart from the insertion hole of the die. In such a configuration, even when the biaxial tilt stage is adjusted with the first axis, the second axis will be misaligned. Accordingly, position of the die may vary left, right, up, and down, and the position of the glass fiber in a radial direction within the insertion hole may vary due to the variation in position of the insertion hole of the die. As a result, the glass fiber may become eccentric in the optical fiber.

### (ii) Resin Coating Device of Comparative Example 2

The resin coating device of Comparative Example 2 will be described as having the configuration of PTL. 1.

The resin coating device of Comparative Example 2 has a flame supporting the die and having an L-shaped cross-section, and a tilt mechanism including two orthogonal central axes of rotation each of which can tilt the frame. In the tilt mechanism of Comparative Example 2, the intersection of the two tilt axes, which serves as a fulcrum during tilting, is located at an outlet of the insertion hole in the die. However, there is a problem that the position of the glass fiber varies during tilting because the glass fiber is less likely to be constrained to the part.

As described below, the pressure gradually decreases at a land portion in the die, and the pressure of the resin is released at the outlet of the insertion hole in the die. Therefore, the resin pressure was lowest near the outlet. On the other hand, within the insertion hole of the die, especially at the tapered portion, the pressure of the resin is relatively higher than that at the outlet, and the pressure of the resin is highest at a part of the tapered portion. Therefore, the glass fiber is constrained to the part where the pressure of the resin is highest in the insertion hole of the die.

Under such circumstances, as in Comparative Example 2, when the die is tilted with respect to the outlet of the insertion hole in the die, a part constraining the glass fiber in the insertion hole will move, and the glass fiber will be pulled by that constraining part. When the glass fiber is pulled as described above, the position of the glass fiber in the radial direction within the insertion hole will vary. When the position of the glass fiber varies within the insertion hole, a difference (disproportion) will occur in a clearance between the insertion hole and the glass fiber. For this reason, the flow of the resin in a circumferential direction in the insertion hole is non-uniform. As a result, the glass fiber is likely to become eccentric in the optical fiber.

In the resin coating device of PTL. 1 as Comparative Example 2, when the die is simultaneously tilted by the two tilt axes, the intersection of the two tilt axes may shift due to the instability of the frame. The tilt mechanism can only tilt the die, and is insufficient as a configuration for rotating the die about a predetermined central axis of rotation.

The present disclosure is based on the above-described knowledges found by the present inventors.

### Embodiments of the Present Disclosure

Next, embodiments of the present disclosure will be listed and described.

[1] A resin coating device according to an aspect of the present disclosure includes:
a resin application portion having an insertion hole through which a glass fiber is inserted in an axial direction, and applying a resin onto an outer circumference of the glass fiber in the insertion hole;
a θₓ rotation mechanism rotating the resin application portion with a θₓ axis orthogonal to a central axis of the insertion hole as a central axis of rotation; and
a θ_{y} rotation mechanism rotating the resin application portion with a θ_{y} axis orthogonal to both of the central axis of the insertion hole and the θₓ axis as a central axis of rotation,
wherein the θₓ rotation mechanism and the θ_{y} rotation mechanism are configured such that a center point of rotation, which is an intersection of the θₓ axis and the θ_{y} axis, is located within the insertion hole.

According to this configuration, the center point of rotation, which is an intersection of both axes, is in the insertion hole, and a tilt angle (inclination) of the resin application portion can be adjusted at that position. This makes it possible to stably suppress eccentricity of the glass fiber in the optical fiber.

[2] In the resin coating device according to [1],
the θₓ rotation mechanism and the θ_{y} rotation mechanism are configured such that the center point of rotation is located upstream of an outlet of the insertion hole in the insertion hole.

According to this configuration, the center point of rotation can be adjusted to a position close to a part where the pressure of the resin is relatively higher in the insertion hole, or to a position close to a part where an amplitude of vibration of the glass fiber is smaller.

[3] In the resin coating device according to [1] or [2],
the θₓ rotation mechanism and the θ_{y} rotation mechanism are configured such that the center point of rotation is located at a part where the pressure of the resin is highest in the insertion hole.

According to this configuration, the tilt angle of the resin application portion can be adjusted based on a part where a force of constraining the glass fiber is strong in the insertion hole.

[4] In the resin coating device according to [1] or [2],
the resin application portion includes:
   a point configured to guide the glass fiber into the insertion hole;
   a first die that is provided downstream of the point in the direction of inserting the glass fiber and applies a first resin on the outer circumference of the glass fiber in the insertion hole; and
   a second die that is provided downstream of the first die in the direction of inserting the glass fiber and applies a second resin on an outer circumference of the first resin applied on the glass fiber in the insertion hole, and
the θₓ rotation mechanism and the θ_{y} rotation mechanism are configured such that the center point of rotation is located at an outlet of the insertion hole in the first die.

According to this configuration, the tilt angle of the resin application portion can be adjusted based on a part to which the glass fiber is constrained.

[5] In the resin coating device according to [1] or [2],
the resin application portion has a point configured to guide the glass fiber into the insertion hole, and
the θₓ rotation mechanism and the θ_{y} rotation mechanism are configured such that the center point of rotation is located at an outlet of the insertion hole in the point.

According to this configuration, the tilt angle of the resin application portion can be adjusted based on a part to which the glass fiber is constrained.

[6] In the resin coating device according to any one of [1] to [5],
the θₓ rotation mechanism is configured as a rotation stage rotatable within a plane normal to the θₓ axis, and
the θ_{y} rotation mechanism is configured as a swivel stage movable along an arc surface at a distance of a predetermined radius from the θ_{y} axis which is the central axis of rotation.

According to this configuration, the center point of rotation can be stably arranged at a predetermined position in the insertion hole.

[7] An apparatus for producing an optical fiber according to another aspect of the present disclosure includes the resin coating device according to any one of [1] to [6].

According to this configuration, eccentricity of the glass fiber in the optical fiber can be stably suppressed.

[8] A method of producing an optical fiber according to yet another aspect of the present disclosure uses the resin coating device according to any one of [1] to [6].

According to this configuration, eccentricity of the glass fiber in the optical fiber can be stably suppressed.

### Details of Embodiment of the Present Disclosure

Next, an embodiment of the present disclosure will be described below with reference to the drawings. The present disclosure is not limited to these illustrations, but intended to be indicated by claims and encompass all the changes which fall within the meaning and scope equivalent to claims.

### One Embodiment of the Present Disclosure

### (1) Optical Fiber

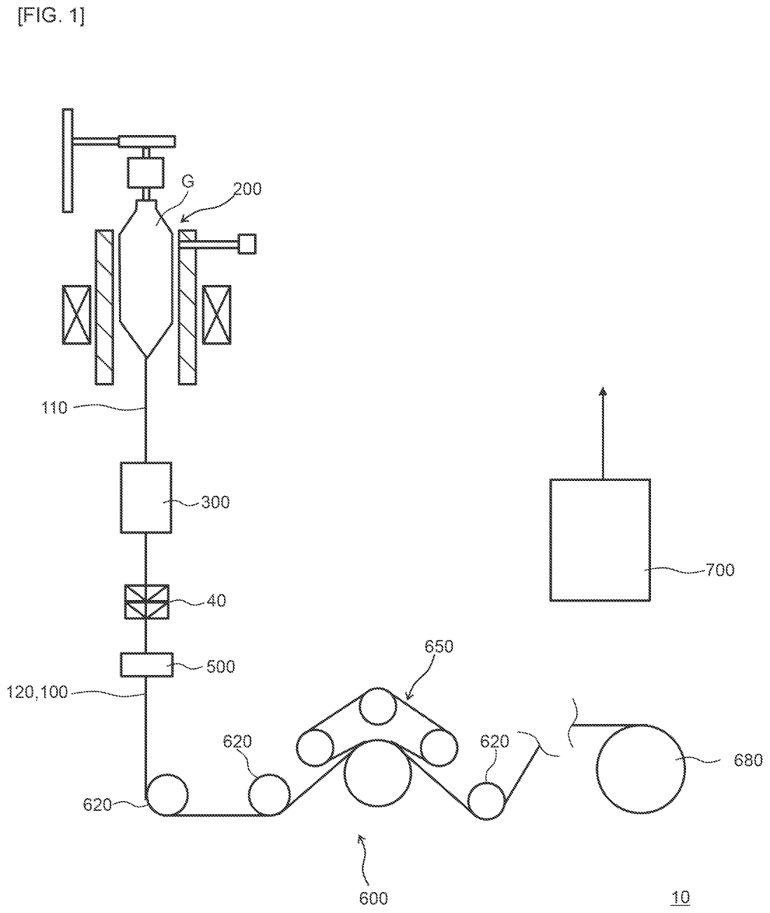

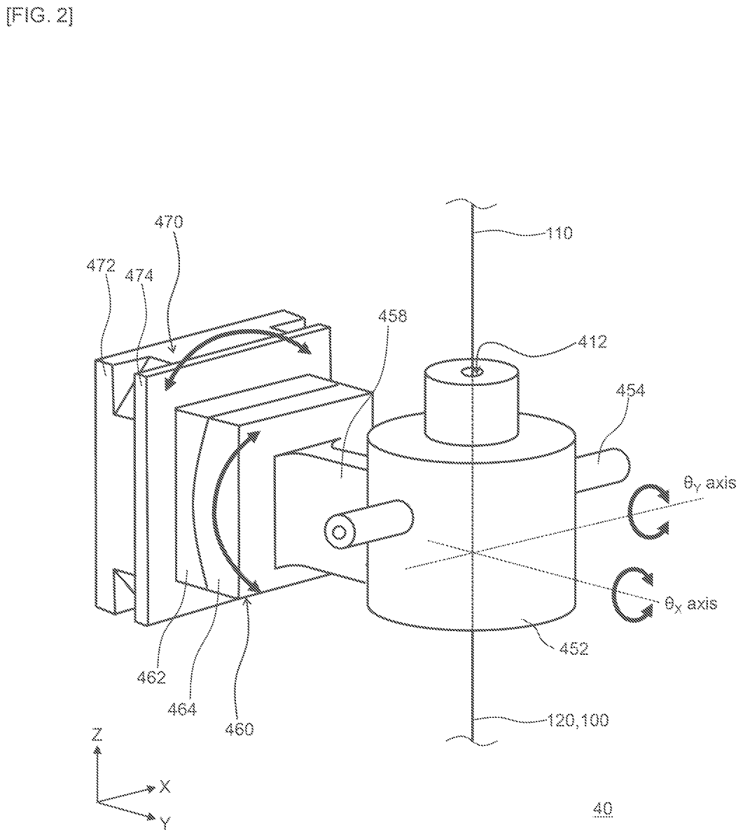

An optical fiber 100 produced by a production method of an embodiment of the present disclosure will be briefly explained. Hereinafter, the numerals attached to the optical fiber 100 and the like correspond to the numerals in FIG. 1 and FIG. 2, which will be described later.

The optical fiber 100 of this embodiment includes, for example, the glass fiber 110 and the resin coating layer 120 in this order from the central axis toward the outer circumference of the glass fiber 110.

The term “optical fiber 100” used herein encompasses an optical fiber before being colored and a colored optical fiber after being colored. Hereinafter, the optical fiber 100 will be explained, for example, as an optical fiber.

The glass fiber 110 uses silica (SiO₂) glass as a base material (main ingredient), and includes a core and a clad.

The resin coating layer 120 is provided, for example, so as to cover the outer circumference of the glass fiber 110, and is configured to protect the glass fiber 110. The resin coating layer 120 contains, for example, a UV curable resin.

In this embodiment, the resin coating layer 120 has, for example, a first resin coating layer (primary resin coating layer) containing a first resin, and a second resin coating layer (secondary resin coating layer) containing a second resin, in this order from a region close to the central axis toward outer circumference of the glass fiber 110.

In the optical fiber 100 having the structure described above, the central axis of the glass fiber 110 is required not to be misaligned with the central axis based on the outer circumference of the resin coating layer 120. Hereinafter, the misalignment of the central axis of the glass fiber 110 within the optical fiber 100 is also referred to as “eccentricity of the glass fiber 110”.

### (2) Apparatus for Producing Optical Fiber

Next, with reference to FIG. 1, an apparatus 10 for producing an optical fiber according to this embodiment will be described. FIG. 1 is a schematic configuration diagram illustrating an apparatus for producing an optical fiber according to this embodiment.

As illustrated in FIG. 1, the apparatus 10 for producing an optical fiber of this embodiment includes, for example, a fiber drawing furnace 200, a cooling device 300, a resin coating device 40, a coating curing device 500, an optical fiber conveying portion 600 including a capstan 650, a winding bobbin 680, and a control portion 700. Note that the members other than the control portion 700 are provided in this order.

Hereinafter, in each member of the apparatus 10 for producing an optical fiber, a region close to the fiber drawing furnace 200 is referred to as “upstream” and a region close to the winding bobbin 680 is referred to as “downstream”.

The fiber drawing furnace 200 is configured to form (draw) the glass fiber 110. A glass matrix G is heated and melted in a fiber drawing furnace 200, and the softened glass is drawn in a vertical direction to form a glass fiber 110 having a small diameter.

The cooling device 300 is configured to cool the glass fiber 110 formed in the fiber drawing furnace 200. A portion for measuring the position of the fiber and a portion for measuring an outer diameter may be provided upstream and downstream of the cooling device 300, respectively.

The resin coating device 40 is configured to form the resin coating layer 120 by applying resin onto the outer circumference of the glass fiber 110 running along the vertical direction. In this embodiment, the resin coating device 40 is configured, for example, as a so-called dual-coat type to continuously apply the first resin and the second resin in this order from a region close to the central axis of the glass fiber 110 toward the outer circumference of the glass fiber 110. The details of the configuration of the resin coating device 40 will be described below.

The coating curing device 500 is configured to irradiate the resin coating layer 120 with UV light to cure the resin coating layer 120.

The optical fiber conveying portion 600 includes, for example, a plurality of guide rollers 620 and a capstan 650. The plurality of guide rollers 620 is configured to convey (run) the optical fiber 100 with the resin coating layer 120 being cured. The capstan 650 is configured to receive the optical fiber 100 while controlling the speed of the optical fiber 100.

The winding bobbin 680 is configured to wind (reel) the optical fiber 100.

The control portion 700 is configured, for example, to be connected to each of portions of the apparatus 10 for producing an optical fiber to control them. The control portion 700 is configured as, for example, a computer.

### (3) Resin Coating Device

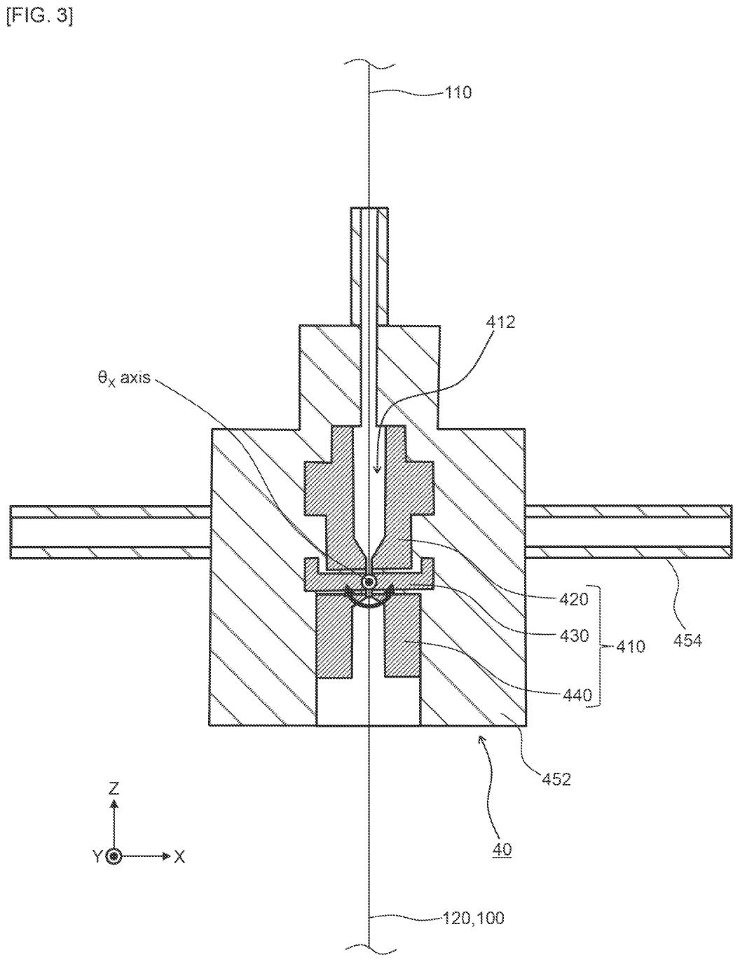

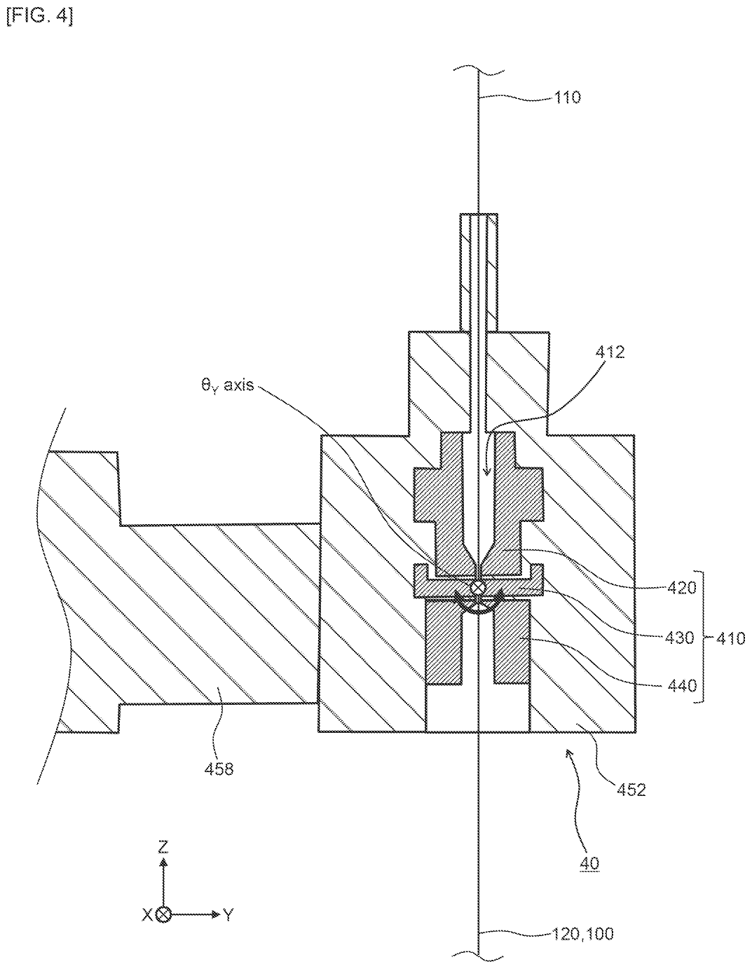

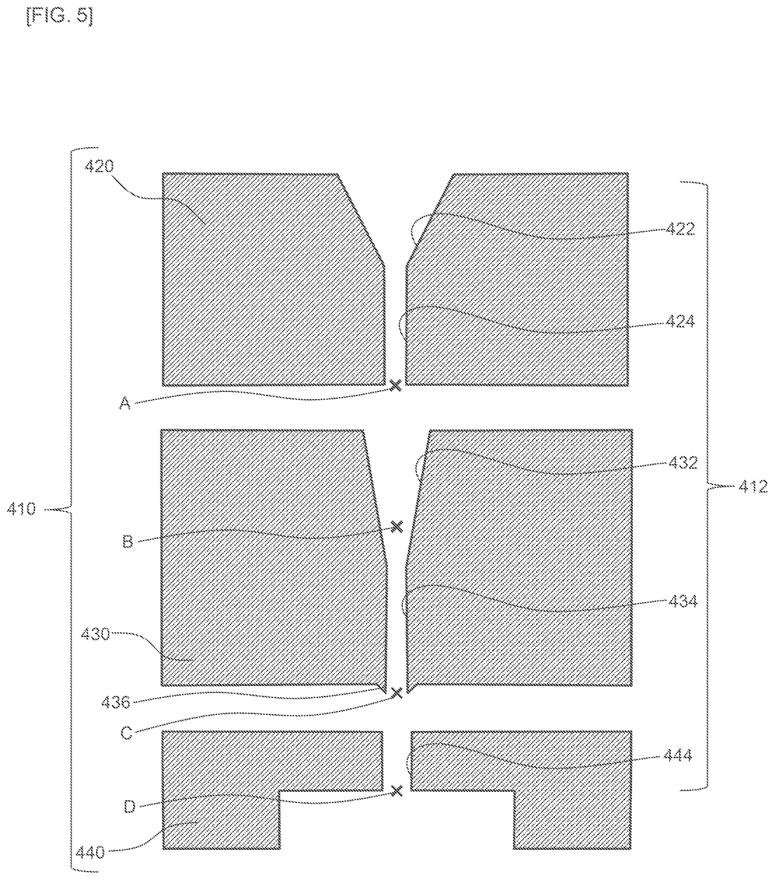

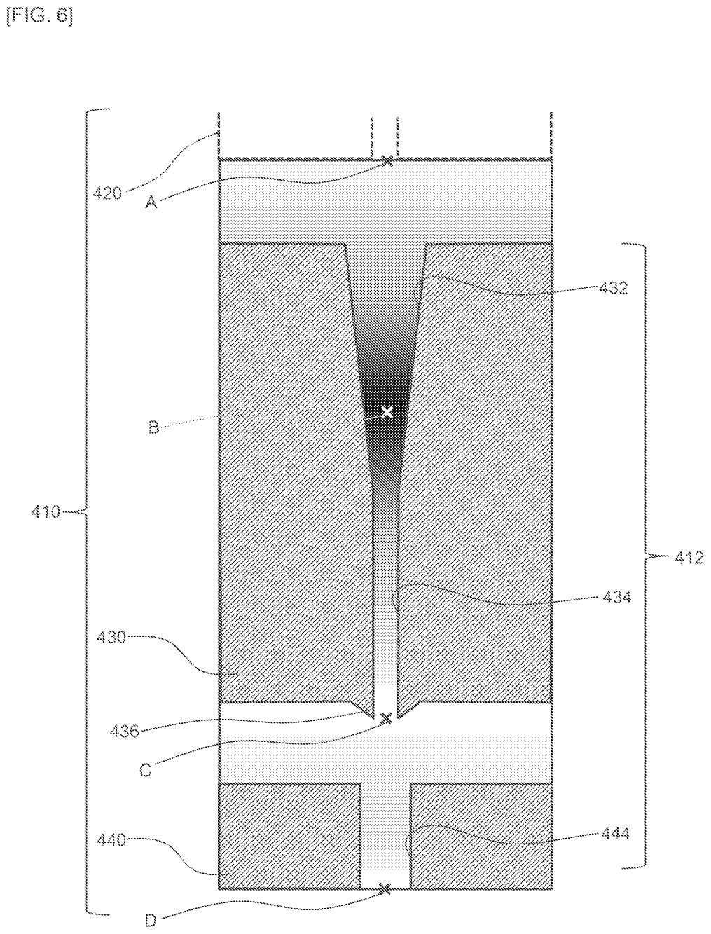

Next, with reference to FIG. 2 to FIG. 6, the resin coating device 40 according to this embodiment will be described. FIG. 2 is a schematic perspective diagram of a resin coating device according to this embodiment. FIG. 3 is a schematic diagram illustrating an XZ cross-section including an insertion hole of a resin application portion in the resin coating device. Note that insertion hole is a hole formed in the center of the resin application portion, through which the glass fiber passes to be coated with a resin liquid. FIG. 4 is a schematic diagram illustrating a YZ cross-section including an insertion hole of the resin application portion in the resin coating device. FIG. 5 is a schematic cross-sectional diagram of the resin application portion. FIG. 6 is a schematic diagram illustrating a resin pressure distribution in the resin application portion.

Note that the glass fiber 110 is omitted in FIG. 5 and FIG. 6. In FIG. 3 to FIG. 6, the resin introduction route is partially omitted or simplified. In FIG. 6, a dark colored part in the insertion hole 412 indicates a part where the pressure of the resin is high.

### Device Configuration

As illustrated in FIG. 2 to FIG. 4, the resin coating device 40 of this embodiment is configured to be able to adjust the tilt angle of the resin application portion 410, for example. Specifically, the resin coating device 40 includes, for example, a resin application portion 410, a holder 452, a support portion 458, a θ_{y} rotation mechanism 460, and a θₓ rotation mechanism 470.

Hereinafter, the “axial direction” of the insertion hole 412 of the resin application portion 410 refers to the direction along the central axis of the insertion hole 412. The “radial direction” of the insertion hole 412 refers to the direction perpendicular to the axial direction of the insertion hole 412. The “circumferential direction” of the insertion hole 412 refers to the direction along the inner circumference of the insertion hole 412. The same terms as those applied to the insertion hole 412 can also be applied to the glass fiber 110 which is inserted through the insertion hole 412.

Hereinafter, an axis parallel to the central axis of the insertion hole 412 of the resin application portion 410 is defined as “Z axis”, two axes which are orthogonal to the Z axis and also orthogonal to each other are defined as “X axis” and “Y axis”.

As illustrated in FIG. 2 to FIG. 6, the resin application portion 410 has the insertion hole 412 through which the glass fiber 110 is inserted in the axial direction. In the insertion hole 412, the resin is applied on the outer circumference of the glass fiber 110.

The resin application portion 410 of this embodiment has, for example, a point (nipple) 420, a first die 430, and a second die 440, in this order from upstream to downstream.

The point 420 is configured to guide the glass fiber 110 through the insertion hole 412, for example. The insertion hole 412 of the point 420 has, for example, a tapered portion 422, and a land portion (straight portion) 424. The tapered portion 422 shrinks in diameter from upstream to downstream, and guides the glass fiber 110 to the central axis of the insertion hole 412. The land portion 424 is connected to the lower end of the tapered portion 422, and linearly extends downstream with a constant diameter.

The point 420 is configured, for example, as a lid member blocking a part which is at a predetermined distance above the first die 430 to apply a predetermined pressure to the resin to be introduced in the insertion hole 412.

The first die 430 is configured, for example, to be provided downstream of the point 420 in the direction of inserting (running) the glass fiber 110, and apply the first resin onto the outer circumference of the glass fiber 110 within the insertion hole 412. The first resin is to be introduced into the insertion hole 412 of the first die 430 through a gap between the above-described point 420 and the first die 430.

The insertion hole 412 of the first die 430 has, for example, a tapered portion 432 and a land portion 434. The tapered portion 432 shrinks in diameter from upstream to downstream. In the tapered portion 432, a pressure of the first resin gradually increases. The land portion 434 is connected to the lower end of the tapered portion 432, and linearly extends downstream with a constant diameter.

Note that the first die 430 of this embodiment has, for example, a protruding portion 436. The protruding portion 436 is provided so as to surround an outlet of the insertion hole 412 in the first die 430. The protruding portion 436 protrudes toward the second die 440 and extends the straight land portion 434. Such a protruding portion 436 can reduce size of a region with low resin pressure generated around an outlet of the land portion 434, and prevent bubbles in the resin from growing in size.

The second die 440 is configured, for example, to be provided downstream of the first die 430 in the direction of inserting the glass fiber 110, and apply the second resin onto the outer circumference of the first resin applied on the glass fiber 110 within the insertion hole 412. The second resin is to be introduced into the insertion hole 412 of the second die 440 through a gap between the above-described first die 430 and second die 440.

The insertion hole 412 of the second die 440 mainly has a land portion 444, for example. The land portion 444 linearly extends from a region close to the first die 430 to downstream with a constant diameter.

The holder 452 is configured, for example, to hold the resin application portion 410. The holder 452 has, for example, a resin introduction path 454 for introducing the resin in the insertion hole 412 of the resin application portion 410. A predetermined pressure gauge (not shown) is provided right in front of an inlet through which the resin in the resin introduction path 454 is introduced, thereby monitoring the resin pressure.

The support portion 458 supports the holder 452, for example, at a position apart from each of the θₓ rotation mechanism 470 and the θ_{y} rotation mechanism 460. The support portion 458 is configured in a columnar (prismatic, cylindrical) shape, for example.

The θ_{y} rotation mechanism 460 is configured to be able to rotate the resin application portion 410 with the θ_{y} axis as the central axis of rotation, for example. The “θ_{y} axis” used herein refers to an axis which is orthogonal to both of the central axis of the insertion hole 412 of the resin application portion 410 (Z axis) and θₓ axis, and is parallel to the X axis.

The θ_{y} rotation mechanism 460 is configured as, for example, a swivel (gonio) stage that is configured to be movable along an arc surface at a distance of a predetermined radius from the θ_{y} axis which is the central axis of rotation. Specifically, the θ_{y} rotation mechanism 460 has, for example, a support base 462, and a swivel (gonio) table 464. The support base 462 is arranged along the vertical direction and has an arc surface. The swivel table 464 is supported on the support base 462 so as to be driven in an arc form along the above-described arc surface by a micrometer (not shown). The swivel table 464 is connected to the above-described support portion 458.

The θₓ rotation mechanism 470 is configured to be able to rotate the resin application portion 410 with the θₓ axis as the central axis of rotation, for example. The “θₓ axis” used herein refers to an axis which is orthogonal to both of the central axis (Z axis) of the insertion hole 412 of the resin application portion 410 and θ_{y} axis, and is parallel to the Y axis.

Specifically, the θₓ rotation mechanism 470 is configured as, for example, a rotation stage that is configured to be rotatable within a plane normal to the θₓ axis. Specifically, the θₓ rotation mechanism 470 has, for example, a support base 472, and a rotary table 474. The support base 472 has a rotary surface normal to the θₓ axis as a central normal. The rotary table 474 is supported rotatably within (or along) the rotary surface described above on the support base 472 by the micrometer (not shown), and supports the support base 462 of the above-described θ_{y} rotation mechanism 460.

In such a configuration, each of the θₓ rotation mechanism 470 and the θ_{y} rotation mechanism 460 is arranged at a position at a predetermined distance from the resin application portion 410 through the holder 452 and the support portion 458, and is configured to be able to rotate the resin application portion 410 with each of the θₓ axis and the θ_{y} axis as the central axis of rotation. Each of the θₓ rotation mechanism 470 and the θ_{y} rotation mechanism 460 is configured, for example, to be connected to the above-described control portion 700 and controllable by the control portion 700.

Note that the resin coating device 40 may further have, for example, a XYZ movable stage, a portion for measuring an outer diameter of the coating, or a portion for detecting anomaly coating. The XYZ movable stage is configured to be able to move the resin application portion 410, the θ_{y} rotation mechanism 460, and the θₓ rotation mechanism 470 as a unit, with respect to the direction of each of three axes (XYZ) of Cartesian coordinate system. The portion for measuring an outer diameter of the coating is configured to measure an outer diameter of the optical fiber 100 with the resin coating layer 120 formed thereon. The portion for detecting anomaly coating is configured to detect anomaly such as bubbles in the resin coating layer 120.

### [Central Axis of Rotation and Center Point of Rotation]

Now, with reference to FIG. 5 and FIG. 6, the θₓ axis and the θ_{y} axis as central axes of rotation of this embodiment, and the center point of rotation will be described.

In this embodiment, the θₓ rotation mechanism 470 and the θ_{y} rotation mechanism 460 are configured, for example, such that the center point of rotation, which is an intersection of the θₓ axis and the θ_{y} axis, is located within the insertion hole 412 of the resin application portion 410. That is, since the θₓ axis and the θ_{y} axis are allowed to intersect with each other, and the center point of rotation, which is an intersection of these axes, is arranged within the insertion hole 412 of the resin application portion 410, variations of the resin application portion 410 other than tilting (left, right, up, and down variations of the resin application portion 410) during adjustment of tilting of the resin application portion 410 can be suppressed.

In this embodiment, the θₓ rotation mechanism 470 and the θ_{y} rotation mechanism 460 may be configured, for example, such that the above-described center point of rotation is located upstream of the outlet (point D) of the insertion hole 412 in the insertion hole 412 of the resin application portion 410. The center point of rotation may be located on the central axis of the insertion hole 412. Accordingly, the above-described center point of rotation can be adjusted to a position close to a part where the pressure of the resin is relatively higher in the insertion hole 412, or to a position close to a part where an amplitude of vibration of the glass fiber 110 is smaller.

More specifically, the θₓ rotation mechanism 470 and the θ_{y} rotation mechanism 460 may match the position of the center point of rotation with any one of the following three points, or be able to move it to any one of the following three points, for example.

As illustrated in FIG. 5 and FIG. 6, in this embodiment, the θₓ rotation mechanism 470 and the θ_{y} rotation mechanism 460 may be configured, for example, such that the center point of rotation is located at a part where the pressure of the resin is highest in the insertion hole 412 of the resin application portion 410. At the position where the pressure is highest, a force of constraining the glass fiber is highest. By adjusting the tilt around this position, the position of the glass fiber is less likely to vary after adjustment.

As illustrated in FIG. 6, in this embodiment, the pressure of the first resin gradually increases as the tapered portion 432 of the first die 430 shrinks in diameter. At the land portion 434 connected to the lower end of the tapered portion 432, the pressure of the first resin is released and slightly reduced. Furthermore, since the second die 440 consists only of the land portion 444, the pressure of the second resin does not increase and becomes lower than that of the first resin. This can prevent the first resin from being crushed by the second resin applied on the outer circumference of the first resin.

As a result, a part where the pressure of the resin is highest in the insertion hole 412 of the resin application portion 410 is located, for example, at a point B slightly upstream of the connection point between the tapered portion 432 and land portion 434 of the first die 430. Accordingly, in this embodiment, for example, the center point of rotation may be located at the point B.

As described above, since the center point of rotation is arranged at the part where the pressure of the resin is highest in the insertion hole 412 of the resin application portion 410, the tilt angle of the resin application portion 410 can be adjusted based on the part where the force of constraining the glass fiber 110 is high in the insertion hole 412.

Alternatively, as illustrated in FIG. 5 and FIG. 6, in this embodiment, the θₓ rotation mechanism 470 and the θ_{y} rotation mechanism 460 may be configured, for example, such that the center point of rotation is located at the outlet (point C) of the insertion hole 412 in the first die 430. In this embodiment, since the first die 430 has the protruding portion 436 at the outlet, the center point of rotation may be located at the center in the radial direction of the protruding portion 436.

Simulation results by the inventors confirm that the amplitude of vibration of the glass fiber 110 can be minimized at the outlet of the insertion hole 412 in the first die 430. In other words, the outlet of the insertion hole 412 in the first die 430 is a “node” of vibration of the glass fiber 110, a part to which the glass fiber 110 is constrained.

As described above, since the center point of rotation is arranged at the outlet of the insertion hole 412 in the first die 430, the tilt angle of the resin application portion 410 can be adjusted based on the part to which the glass fiber 110 is constrained.

Alternatively, as illustrated in FIG. 5 and FIG. 6, in this embodiment, the θₓ rotation mechanism 470 and the θ_{y} rotation mechanism 460 may be configured, for example, such that the center point of rotation is located at the outlet (point A) of the insertion hole 412 in the point 420.

Simulation results by the inventors confirm that an outlet of the insertion hole 412 in the point 420 can be the above-described node of vibration of the glass fiber 110.

As described above, since the center point of rotation is arranged at the outlet of the insertion hole 412 in the point 420, the tilt angle of the resin application portion 410 can be adjusted based on the part to which the glass fiber 110 is constrained, similar to the effect of the second point.

In this embodiment, the above-described aspect in which “the θₓ rotation mechanism 470 and the θ_{y} rotation mechanism 460 are configured such that the center point of rotation is located at a predetermined part” is not limited to an aspect in which the center point of rotation of the θₓ rotation mechanism 470 and the θ_{y} rotation mechanism 460 coincides with the above-described part in terms of design. For example, the θₓ rotation mechanism 470 and the BY rotation mechanism 460 may be configured such that the center point of rotation can be moved to the predetermined part described above by the XYZ movable stage.

### (4) Method of Producing Optical Fiber

Next, the method of producing optical fiber 100 according to this embodiment will be described.

In the method of producing optical fiber 100 according to this embodiment, the apparatus 10 for producing an optical fiber including the resin coating device 40 is firstly prepared. In this event, position adjustment of the center point of rotation in the resin coating device 40 may be performed at the device design stage, or may be performed using the XYZ movable stage before or during production of the optical fiber 100.

After preparing the above-described apparatus 10 for producing an optical fiber, the apparatus 10 for producing an optical fiber is used through a sequence of: the fiber drawing furnace 200, the cooling device 300, the resin coating device 40, the coating curing device 500 and the optical fiber conveying portion 600, in this order.

In this event, after drawing of the glass fiber 110 is stabilized, the control portion 700 controls so that the θₓ rotation mechanism 470 and the θ_{y} rotation mechanism 460 adjust the tilt angle of the resin application portion 410 and reduce the eccentricity of the glass fiber 110, for example, based on the measurement results by the portion for measuring an outer diameter of the coating, the portion for detecting anomaly coating, and the like in the resin coating device 40.

According to the method described above, the optical fiber 100 of this embodiment is produced

### (5) Summary of this Embodiment

According to this embodiment, one or more effects described below are achieved.

(a) In this embodiment, the θₓ rotation mechanism 470 and the θ_{y} rotation mechanism 460 are configured such that the center point of rotation, which is an intersection of the θₓ axis and the θ_{y} axis, is located within the insertion hole 412 of the resin application portion 410. That is, the θₓ axis and the θ_{y} axis are allowed to intersect with each other, and the center point of rotation, which is an intersection of these axes, is arranged within the insertion hole 412 of the resin application portion 410, so that the tilt angle (inclination) of the resin application portion 410 can be adjusted based on this position. Accordingly, variations of the resin application portion 410 other than tilting (left, right, up, and down variations of the resin application portion 410) during adjustment of tilting of the die 710 can be suppressed.

By suppressing the variations other than tilting of the resin application portion 410, the position of the glass fiber 110 in the insertion hole 412 can be stabilized. The clearance between (the inner wall of) the insertion hole 412 and the glass fiber 110 can be made uniform over the entire circumference of the insertion hole 412. The flow of the resin can be made uniform in the circumferential direction of the insertion hole 412 with the glass fiber 110 as the center, and the resin can be applied uniformly over the entire outer circumference of the glass fiber 110. As a result, it is possible to stably suppress eccentricity of the glass fiber 110 in the optical fiber 100.

(b) In this embodiment, the θₓ rotation mechanism 470 and the θ_{y} rotation mechanism 460 are configured such that the above-described center point of rotation is located upstream of the outlet (point D) of the insertion hole 412 in the insertion hole 412 of the resin application portion 410. Accordingly, the above-described center point of rotation can be adjusted to a position close to a part where the pressure of the resin is relatively higher in the insertion hole 412, or to a position close to a part where an amplitude of vibration of the glass fiber 110 is smaller.

(c) In this embodiment, the θₓ rotation mechanism 470 and the θ_{y} rotation mechanism 460 may be configured such that the center point of rotation is located at a part where the pressure of the resin is highest in the insertion hole 412 of the resin application portion 410. At the part where the pressure of the resin is highest in the insertion hole 412 of the resin application portion 410, the force of constraining the glass fiber 110 toward the central axis in the radial direction of the insertion hole 412 (force of constraining the glass fiber 110, self-centering force) is stronger due to the resin with high pressure. As described above, since the center point of rotation is arranged at the part where the pressure of the resin is highest, the tilt angle of the resin application portion 410 can be adjusted based on the part where the force of constraining the glass fiber 110 is high in the insertion hole 412.

Since the part where the force of constraining the glass fiber 110 is high is used as a basis, the part where the force of constraining the glass fiber 110 is high can be prevented from moving, and the glass fiber 110 can be prevented from being pulled toward the part where the force of constraining is high, when the resin application portion 410 is tilted. In other words, variation of the glass fiber 110 in the insertion hole 412 can be suppressed. As a result, it is possible to stably suppress eccentricity of the glass fiber 110 in the optical fiber 100.

(d) Alternatively, in this embodiment, the θₓ rotation mechanism 470 and the θ_{y} rotation mechanism 460 may be configured such that the center point of rotation is located at the outlet (point C) of the insertion hole 412 in the first die 430. Accordingly, as described above, the tilt angle of the resin application portion 410 can be adjusted based on the part which is a “node” of vibration of the glass fiber 110 and to which the glass fiber 110 is constrained.

Since the part to which the glass fiber 110 is constrained is used as a basis, it is possible to prevent the part to which the glass fiber 110 is constrained from moving, and the glass fiber 110 from being pulled toward that constraint part, when the resin application portion 410 is tilted. As a result, it is possible to stably suppress eccentricity of the glass fiber 110 in the optical fiber 100, as in (c).

(e) Alternatively, in this embodiment, the θₓ rotation mechanism 470 and the θ_{y} rotation mechanism 460 may be configured such that the center point of rotation is located at the outlet (point A) of the insertion hole 412 in the point 420. Accordingly, as described above, the tilt angle of the resin application portion 410 can be adjusted based on the part to which the glass fiber 110 is constrained. As a result, it is possible to stably suppress eccentricity of the glass fiber 110 in the optical fiber 100, as in (c) and (d).

(f) In this embodiment, the θₓ rotation mechanism 470 is configured as a rotation stage that is configured to be rotatable within a plane normal to the θₓ axis. The θ_{y} rotation mechanism 460 is configured as a swivel stage that is configured to be movable along the arc surface at a distance of a predetermined radius from the θ_{y} axis which is the central axis of rotation.

The above-described configuration makes it possible for the θₓ axis and the θ_{y} axis to be intersected with ease at high accuracy. Accordingly, the center point of rotation as an intersection of the θₓ axis and the θ_{y} axis can be stably arranged (maintained) at a predetermined position in the insertion hole 412.

The above-described configuration makes it possible to arrange the center point of rotation at a position away from each of the θₓ rotation mechanism 470 and the θ_{y} rotation mechanism 460. Accordingly, an opening corresponding to the insertion hole 412 of the resin application portion 410 does not have to be formed in each of the θₓ rotation mechanism 470 and the θ_{y} rotation mechanism 460.

According to the above-described configuration, it is possible to separate the insertion hole 412 of the resin application portion 410 from each of the θₓ rotation mechanism 470 and the By rotation mechanism 460, while the center point of rotation of the θₓ rotation mechanism 470 and the θ_{y} rotation mechanism 460 is arranged within the insertion hole 412 of the resin application portion 410. Accordingly, when resin leakage from the resin application portion 410 occurs, it is possible for the θₓ rotation mechanism 470 and the θ_{y} rotation mechanism 460 to avoid the effect of the resin leakage. As a result, it is possible to facilitate maintenance of the resin coating device 40.

The above-described rotation stage and swivel stage enable stable rotation of the resin application portion 410 compared to the configuration of Comparative Example 2, which only tilts a die. Compared to Comparative Example 2, the respective support bases of the rotation stage and the swivel stage can be brought into surface contact with each other, and the θₓ rotation mechanism 470 and the θ_{y} rotation mechanism 460 can be stably fixed.

### Other Embodiments of the Present Disclosure

Although embodiment of the present disclosure has been specifically described, the present disclosure is not limited to the embodiment described above, and various modifications can be made without departing from the gist of the present disclosure.

In the above-described embodiment, the optical fiber 100 is illustrated and described as an optical fiber before being colored, but the present disclosure is not limited to the case. As described above, the optical fiber 100 may be a colored optical fiber after being colored. In other words, the optical fiber 100 may have a colored layer covering the outer circumference of the resin coating layer 120.

In the above-described embodiment, a case in which the resin coating device 40 is configured as a so-called dual-coat type is described, but the present disclosure is not limited to the case. The resin coating device 40 may be configured as a single-coat type, and the resin application portion 410 may have only one die (first die 430). In this case, since the resin application portion 410 does not have the second die 440, a configuration in which “the center point of rotation is located at the outlet of the insertion hole 412 in the first die 430” does not have to be applied.

In the above-described embodiment, an aspect in which the θₓ rotation mechanism 470, the θ_{y} rotation mechanism 460, the support portion 458, and the holder 452 are connected in this order is described, but the present disclosure is not limited to the aspect. The arrangement of the θₓ rotation mechanism 470 and the θ_{y} rotation mechanism 460 may be contrary to the arrangement of the above-described embodiment.

What is claimed is:

1. A resin coating device, comprising:
a resin application portion having an insertion hole through which a glass fiber is inserted in an axial direction, and applying a resin onto an outer circumference of the glass fiber in the insertion hole;
a θₓ rotation mechanism rotating the resin application portion with a θₓ axis orthogonal to a central axis of the insertion hole as a central axis of rotation; and
a θ_{y} rotation mechanism rotating the resin application portion with a θ_{y} axis orthogonal to both of the central axis of the insertion hole and the θₓ axis as a central axis of rotation,
wherein the θₓ rotation mechanism and the θ_{y} rotation mechanism are configured such that a center point of rotation, which is an intersection of the θₓ axis and the θ_{y} axis, is located within the insertion hole.

2. The resin coating device according to claim 1,
wherein the θₓ rotation mechanism and the θ_{y} rotation mechanism are configured such that the center point of rotation is located upstream of an outlet of the insertion hole in the insertion hole.

3. The resin coating device according to claim 1,
wherein the θₓ rotation mechanism and the θ_{y} rotation mechanism are configured such that the center point of rotation is located at a part where the pressure of the resin is highest in the insertion hole.

4. The resin coating device according to claim 1,
wherein the resin application portion includes:
a point configured to guide the glass fiber into the insertion hole;
a first die that is provided downstream of the point in the direction of inserting the glass fiber and applies a first resin on the outer circumference of the glass fiber in the insertion hole; and
a second die that is provided downstream of the first die in the direction of inserting the glass fiber and applies a second resin on an outer circumference of the first resin applied on the glass fiber in the insertion hole, and
the θₓ rotation mechanism and the θ_{y} rotation mechanism are configured such that the center point of rotation is located at an outlet of the insertion hole in the first die.

5. The resin coating device according to claim 1,
wherein the resin application portion has a point configured to guide the glass fiber into the insertion hole, and
the θₓ rotation mechanism and the θ_{y} rotation mechanism are configured such that the center point of rotation is located at an outlet of the insertion hole in the point.

6. The resin coating device according to claim 1,
wherein the θₓ rotation mechanism is configured as a rotation stage rotatable within a plane normal to the θₓ axis, and
the θ_{y} rotation mechanism is configured as a swivel stage movable along an arc surface at a distance of a predetermined radius from the θ_{y} axis which is the central axis of rotation.

7. An apparatus for producing an optical fiber, comprising the resin coating device according to claim 1.

8. A method of producing an optical fiber, using the resin coating device according to claim 1.
